(19) United States
(12) Patent Application Publication
(10) Pub. No.: US 2010/0174884 A1
(43) Pub. Date: Jul. 8, 2010

(54) PROCESSOR HAVING RECONFIGURABLE ARITHMETIC ELEMENT

(75) Inventors: Hiroyuki Morishita, Osaka (JP); Takao Yamamoto, Osaka (JP); Masaitsu Nakajima, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/159,271

(22) PCT Filed: Nov. 9, 2006
(86) PCT No.: PCT/JP2006/322334

§ 371 Date: Jun. 26, 2008

(30) Foreign Application Priority Data
Dec. 27, 2005 (JP) 2005-376572

(51) Int. Cl. G06F 9/302; G06F 9/30; G06F 15/80; G06F 9/06

(52) U.S. Cl. 712/15; 712/221; 712/215; 712/E09.017; 712/E09.016; 712/E09.003

(57) ABSTRACT

A processor (101) in which a plurality of arithmetic elements executing instructions are embedded includes: fixed function arithmetic elements (121 to 123) each having a circuit configuration that is not dynamically reconfigurable; a reconfigurable arithmetic element (125) having a circuit configuration that is dynamically reconfigurable; and an arithmetic operation control unit (113) which allocates instructions to the fixed function arithmetic elements (121 to 123) and the reconfigurable arithmetic element (125) and issues the allocated instructions to the respective arithmetic elements.

### TECHNICAL FIELD

The present invention relates to processors having dynamically-reconfigurable arithmetic elements, and more particularly to a processor having flexibility and a high processing speed while reducing a circuit size of dynamically-reconfigurable arithmetic elements.

### BACKGROUND ART

In recent years, dedicated hardware, high-performance digital signal processors (DSPs), and the like have been embedded in apparatuses for processing digitalized video and audio (hereinafter, referred to as “digital AV apparatuses”). This is because the digital AV apparatuses have a large arithmetic amount for processing digitalized video and audio, such as compressing and extending processing.

Moreover, a great variety of standards for digitalizing video and audio, such as a Moving Picture Experts Group (MPEG)-2, a MPEG-4, an H.263, and an H.264, have been widely used. With the increase of standards, digital AV apparatuses compliant to a plurality of standards are required. To meet this requirement, (1) a method of realizing the multi-standard processing using hardware and (2) a method of realizing the multi-standard processing using software have been conceived. Here, in the case of (1) the method using hardware, a high processing speed can be achieved. However, an additional hardware is necessary to add a new function. Furthermore, a large number of functions increases a circuit size. On the other hand, in the case of (2) the method using software, flexibility can be achieved. By the method (2), a large number of functions can be implemented as software, so that new functions can be added easily. However, the method (2) has a difficulty in increasing a processing speed.

To meet the above challenges, a technology is suggested which performs the multi-standard processing using a processor having dynamically-reconfigurable circuits (refer to Patent Reference 1, for example). By the technology, a processor can achieve both of the flexibility and the high processing speed.

Patent Reference 1: International Publication No. WO 2002/095946.

### DISCLOSURE OF INVENTION

### Problems that Invention is to Solve

However, as disclosed in the prior art, the processor having dynamically-reconfigurable circuits has a problem of increasing a circuit size, since the processor includes a large number of arithmetic elements and changes wiring among the arithmetic elements, thereby flexibly configuring the arithmetic elements.

In order to address the above problem, an object of the present invention is to provide a processor having flexibility and a high processing speed while reducing a circuit size of dynamically-reconfigurable arithmetic elements.

### Means to Solve the Problems

In accordance with a first aspect of the present invention for achieving the object, there is provided (a) a processor in which a plurality of arithmetic elements that execute instructions are embedded, the processor including: (b) a fixed function arithmetic element having a circuit configuration which is not dynamically reconfigurable; (c) a reconfigurable arithmetic element having a circuit configuration which is dynamically reconfigurable; (d) an instruction allocation unit operable to allocate each instruction to the fixed function arithmetic element or the reconfigurable arithmetic element, the instruction being included in a set of instructions which do not have any data dependency between the instructions; and (e) an instruction issuing unit operable to issue the allocated instruction to an allocation destination that is the fixed function arithmetic element or the reconfigurable arithmetic element to which the allocated instruction is allocated by the instruction allocation unit.

With the above structure, the processor according to the present invention includes not only common fixed function arithmetic elements, but also a reconfigurable arithmetic element having a dynamically-reconfigured circuit configuration. Furthermore, when instructions to be executed in parallel are decided, the reconfigurable arithmetic element having a changeable function is allocated with suitable instructions. Thereby, the processor according to the present invention can achieve flexibility and a high processing speed while reducing a circuit size.

It should be noted that the present invention can be realized not only as the processor, but also as an information processing apparatus having the processor, a processor control method for controlling the processor, a method of controlling the information processing apparatus, and the like.

### EFFECTS OF THE INVENTION

According to the present invention, regarding a processor having dynamically-reconfigurable arithmetic elements, arithmetic elements which are reconfigurable hardware perform instruction scheduling and instruction issuing so that a various kinds of instructions can be executed at the same time. Thereby, it is possible to provide a structure of the processor by which high-performance and flexible processing can be achieved while preventing increase of a circuit size.

### BRIEF DESCRIPTION OF DRAWINGS

FIG. 1 is a diagram showing a structure of a processor according to the first embodiment of the present invention.

FIG. 2 is a flowchart of processing performed by the processor according to the first embodiment of the present invention.

FIG. 3A is a table showing one example of an instruction set executed in the processor according to the first embodiment of the present invention.

FIG. 3B is a table showing one example of another instruction set executed in the processor according to the first embodiment of the present invention.

FIG. 3C is a diagram showing structures of arithmetic elements in an arithmetic unit of the processor according to the first embodiment of the present invention.

FIG. 4 is a diagram showing a structure of a processor according to the second embodiment of the present invention.

FIG. 5 is a flowchart of processing performed by the processor according to the second embodiment of the present invention.

FIG. 6A is a table showing one example of an instruction set executed in the processor according to the second embodiment of the present invention.

FIG. 6B is a diagram showing structures of arithmetic elements in an arithmetic unit of the processor according to the second embodiment of the present invention.

FIG. 7 is a diagram showing a structure of a processor according to the third embodiment of the present invention.

FIG. 8 is a flowchart of processing performed by the processor according to the third embodiment of the present invention.

FIG. 9A is a table showing one processing example of the instruction set executed in the processor according to the third embodiment of the present invention.

FIG. 9B is a table showing one processing example of the instruction set executed in the processor in the case where a configuration instruction is not inserted into an instruction set, according to the third embodiment of the present invention.

FIG. 9C is a table showing one processing example of the instruction set executed in the processor in the case where a configuration instruction is inserted into an instruction set, according to the third embodiment of the present invention.

FIG. 10 is a diagram showing a structure of an information processing apparatus in which a processor according to the fourth embodiment of the present invention is embedded.

FIG. 11 is a diagram showing a structure of the processor according to the fourth embodiment of the present invention.

FIG. 12 is a flowchart of one example of processing performed by a generation unit in the processor according to the fourth embodiment of the present invention.

FIG. 13 is a flowchart of a variation of the processing performed by the generation unit in the processor according to the fourth embodiment of the present invention.

FIG. 14 is a diagram showing a structure of an information processing apparatus in which a processor according to the fifth embodiment of the present invention is embedded.

FIG. 15 is a table showing circuit configurations in associated with software programs to be executed in the processor according to the fifth embodiment of the present invention.

FIG. 16 is a graph showing one example of the case where a plurality of software programs are executed by time-sharing by the processor according to the fifth embodiment of the present invention.

### NUMERICAL REFERENCES

101, 201, 301, 401 processor
102 instruction storage unit
103, 403, 503 configuration information hold unit
111, 411 instruction fetching unit
112 instruction decoding unit
113, 213, 313, 413 arithmetic operation control unit
114 register file
115, 215, 315, 415 arithmetic unit
121-123 fixed function arithmetic element
131 instruction hold unit
132 instruction selection unit
133, 233 instruction allocation unit
134, 234, 334 configuration control unit
135 instruction issue unit
125, 225, 325, 425 reconfigurable arithmetic element
400, 500 information processing apparatus
404, 504 generation unit
405, 505 configuration control unit
406 software program hold unit
407 template hold unit

### BEST MODE FOR CARRYING OUT THE INVENTION

### First Embodiment

The following describes the first embodiment of the present invention with reference to the drawings.

The processor according to the first embodiment is (a) a processor in which a plurality of arithmetic elements that execute instructions are embedded, the processor including: (b) a fixed function arithmetic element having a circuit configuration which is not dynamically reconfigurable; (c) a reconfigurable arithmetic element having a circuit configuration which is dynamically reconfigurable; (d) an instruction allocation unit operable to allocate each instruction to the fixed function arithmetic element or the reconfigurable arithmetic element, the instruction being included in a set of instructions which do not have any data dependency between the instructions; and (e) an instruction issuing unit operable to issue the allocated instruction to an allocation destination that is the fixed function arithmetic element or the reconfigurable arithmetic element to which the allocated instruction is allocated by the instruction allocation unit.

Further, the instruction allocation unit may allocate the instruction to the fixed function arithmetic element prior to the reconfigurable arithmetic element. Furthermore, the instruction issuing unit may issue a plurality of the allocated instructions in parallel to the allocation destinations, respectively.

Still further, the processor according to the first embodiment may further include a configuration control unit operable to direct the reconfigurable arithmetic element to dynamically reconfigure a circuit configuration of the reconfigurable arithmetic element based on configuration information, when a predetermined instruction is allocated to the reconfigurable arithmetic element but the circuit configuration of the reconfigurable arithmetic element is not compliant to the predetermined instruction, the configuration information defining a circuit configuration compliant to the predetermined instruction.

Based on the above aspects, the processor according to the first embodiment is described below.

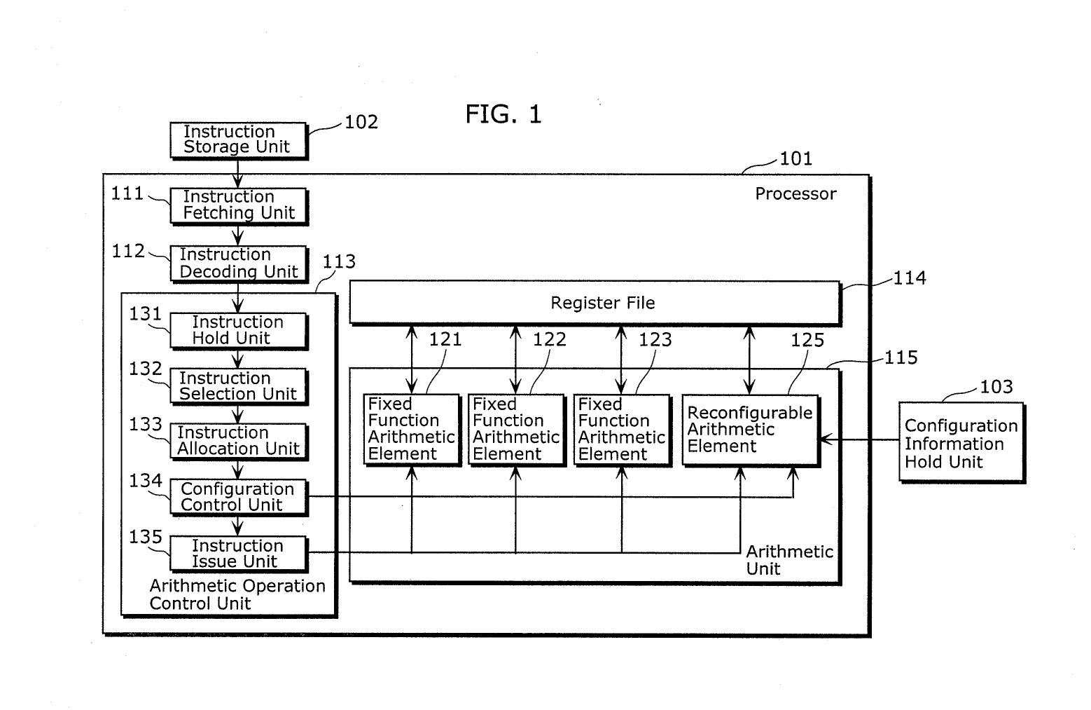

FIG. 1 is a diagram showing the structure of the processor according to the first embodiment. As shown in FIG. 1, the processor 101 is a processor which executes a sequence of instructions stored in an instruction storage unit 102 by using a plurality of arithmetic elements at the same time. Here, as the plurality of arithmetic elements, the processor 101 includes fixed function arithmetic elements 121 to 123 and a reconfigurable arithmetic element 125, for example. Each of the fixed function arithmetic elements 121 to 123 is an arithmetic element having a circuit configuration which cannot be dynamically reconfigured. The reconfigurable arithmetic element 125 is an arithmetic element having a circuit configuration which can be dynamically reconfigured. For example, when reconfiguration of the circuit configuration is directed, a piece of configuration information defining the directed circuit configuration is selected from among pieces of configuration information stored in the configuration information hold unit 103, and the circuit configuration is reconfigured based on the selected configuration information.

The “configuration information” is information defining a circuit configuration compliant to one or more instructions executable by an arithmetic element to be reconfigured.

More specifically, the processor 101 includes an instruction fetching unit 111, an instruction decoding unit 112, an arithmetic operation control unit 113, a register file 114, and an arithmetic unit 115.

The instruction fetching unit 111 reads out instructions to be executed by the processor 101 from the instruction storage unit 102, and provides the instructions to the instruction decoding unit 112. The instruction decoding unit 112 receives the instructions provided from the instruction fetching unit 111 and decodes the received instructions. The arithmetic operation control unit 113 controls the arithmetic unit 115 based on results of the decoding performed by the instruction decoding unit 112. The register file 114 holds data used by the arithmetic unit 115 and results of arithmetic operation performed by the arithmetic unit 115. The arithmetic unit 115 has the above-mentioned fixed function arithmetic elements 121 to 123 and the reconfigurable arithmetic element 125, and executes arithmetic operations compliant to each instruction.

Furthermore, the arithmetic operation control unit 113 includes an instruction hold unit 131, an instruction selection unit 132, an instruction allocation unit 133, a configuration control unit 134, and an instruction issue unit 135.

The instruction hold unit 131 holds instructions decoded by the instruction decoding unit 112. The instruction selection unit 132 selects one or more instructions which do not have data dependency among them, from among the instructions which are held in the instruction hold unit 131 and have not yet been issued.

The instruction allocation unit 133 allocates each of one or more instructions selected by the instruction selection unit 132, to corresponding one of the fixed function arithmetic elements 121 to 123 and the reconfigurable arithmetic element 125. Here, the instructions are allocated by prioritizing the fixed function arithmetic elements 121 to 123 over the reconfigurable arithmetic element 125.

When a circuit configuration of the reconfigurable arithmetic element 125 is not compliant to an instruction allocated to the reconfigurable arithmetic element 125, the configuration control unit 134 dynamically reconfigures the circuit configuration of the reconfigurable arithmetic element 125 based on the configuration information defining a circuit configuration compliant to the instruction.

The instruction issue unit 135 issues the independently allocated instructions to the arithmetic elements to which the instructions are allocated, respectively. Here, the independently allocated instructions are issued in parallel to the respective arithmetic elements to which the instructions are allocated.

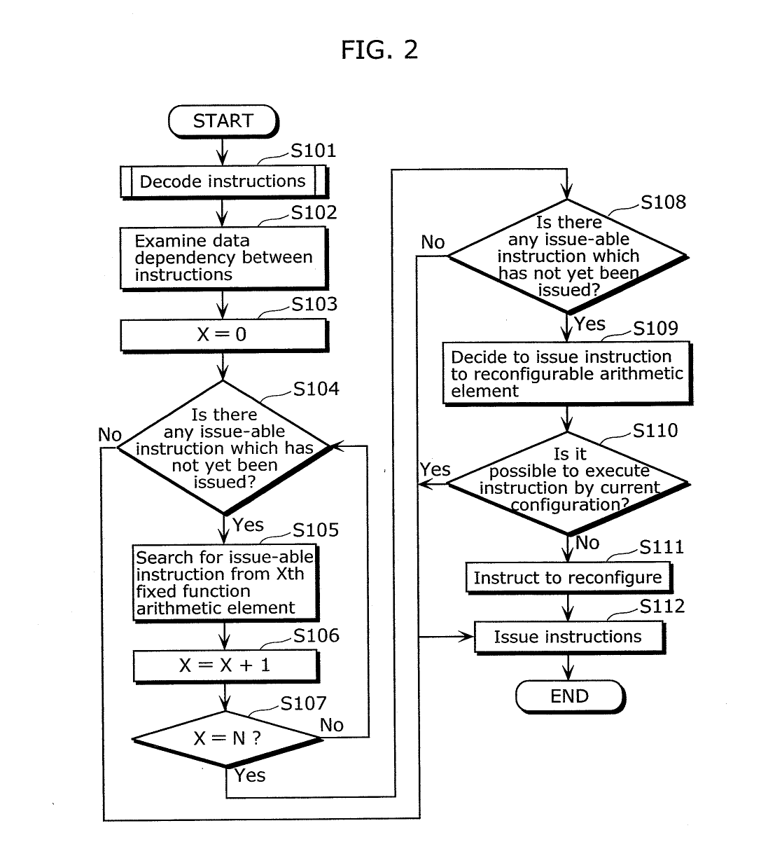

FIG. 2 is a flowchart of the processing performed by the processor according to the first embodiment of the present invention. With reference to FIG. 2, the following describes processing from decoding of instructions to issuing of the decoded instruction.

Firstly, the instruction decoding unit 112 decodes instructions received from the instruction fetching unit 111 (S101).

Subsequently, the arithmetic operation control unit 113 (instruction hold unit 131) holds instructions decoded by the instruction decoding unit 112.

The arithmetic operation control unit 113 (instruction selection unit 132) examines data dependency among the instructions which are held in the instruction hold unit 131 and have not yet been issued. In addition, the arithmetic operation control unit 113 selects instructions which do not have any data dependency among them, from the instructions which are held in the instruction hold unit 131 and have not yet been issued (S102).

The arithmetic operation control unit 113 (instruction allocation unit 133) initializes a variable X which is used to search for an index assigned to each of the fixed function arithmetic elements (S103). Then, the arithmetic operation control unit 113 (instruction allocation unit 133) determines whether or not there is still any instruction which has not yet been issued, namely there is still any instruction which does not have any data dependency with another (S104). If the determination is made that there is still an instruction which does not have any data dependency with another (Yes at S104), then issue-able instructions except the allocated instructions are searched from the instructions which do not have any data dependency among them, to be allocated to the fixed function arithmetic elements 121 to 123, respectively (S105 to S107).

Then, the arithmetic operation control unit 113 (instruction allocation unit 133) determines whether or not there is still further any instruction which does not have any data dependency with another (S108). If the determination is made that there is still an instruction which does not have any data dependency with another (Yes at S108), then instructions issue-able to the reconfigurable arithmetic element 125 except the allocated instructions are searched from the instructions which do not have any data dependency among them, to be allocated to the reconfigurable arithmetic element 125 (S109). Here, from among the searched instructions, the instruction which has been decoded the earliest is allocated to the reconfigurable arithmetic element 125.

The arithmetic operation control unit 113 (configuration control unit 134) determines whether or not the instruction allocated to the reconfigurable arithmetic element 125 can be executed by a current circuit configuration of the reconfigurable arithmetic element 125 (S110). If the determination is made that the instruction cannot be executed by the current circuit configuration of the reconfigurable arithmetic element 125 (No at S110), then the arithmetic operation control unit 113 (configuration control unit 134) directs the reconfigurable arithmetic element 125 to reconfigure the current circuit configuration (S111).

Then, the arithmetic operation control unit 113 (instruction issue unit 135) issues these allocated instructions to the fixed function arithmetic elements 121 to 123 and the reconfigurable arithmetic element 125, respectively (S112).

Here, if the determination is made that there is still an instruction which does not have any data dependency with another (No at S104), or if the determination is made that the instruction allocated to the reconfigurable arithmetic element 125 can be executed by the current circuit configuration of the reconfigurable arithmetic element 125 (Yes at S110), the arithmetic operation control unit 113 (instruction issue unit 135) issues these allocated instructions to the fixed function arithmetic elements 121 to 123 and the reconfigurable arithmetic element 125, respectively.

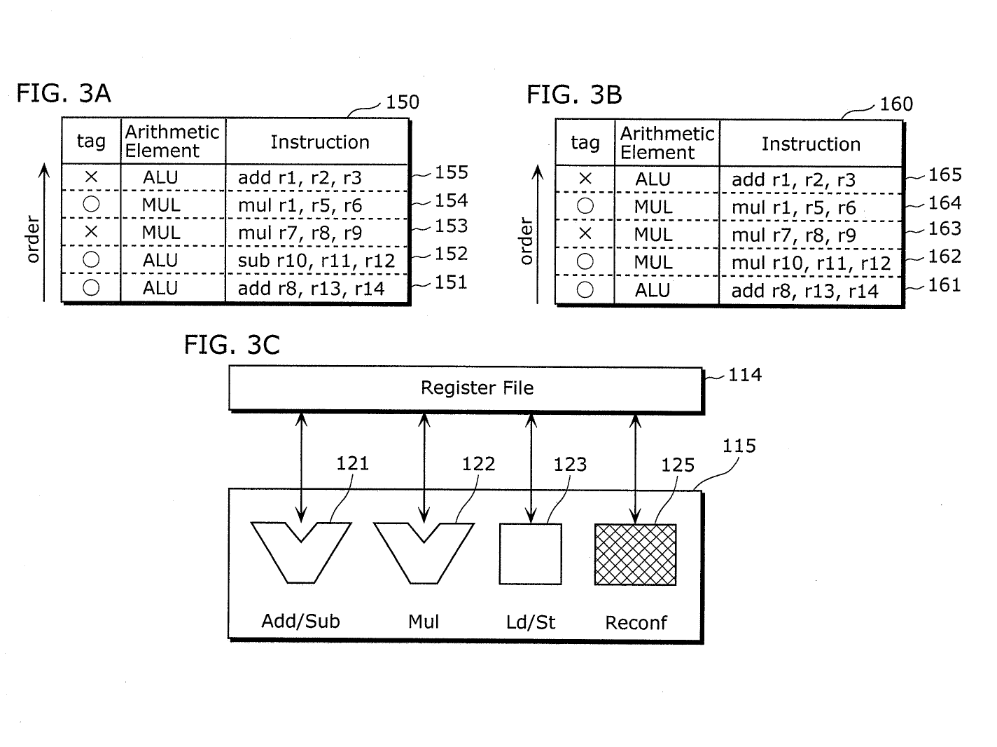

FIGS. 3A and 3B are tables each showing a set of instructions (hereinafter, referred to as an “instruction set”) executed by the processor according to the first embodiment. FIG. 3C is a diagram showing structures of the arithmetic elements in the arithmetic unit of the processor according to the first embodiment. Here, as one example, as shown in FIG. 3A, the following instruction set 150 (instructions 151 to 155) is stored in the arithmetic operation control unit 113 (instruction hold unit 131) in an chronological order of decoding.

(Instruction 151) add r8, r13, r14 (r13+r14→r8)

(Instruction 152) sub r10, r11, r12 (r11−r12→r10)

(Instruction 153) mul r7, r8, r9 (r8*r9→r7)

(Instruction 154) mul r1, r5, r6, (r5*r6→r1)

(Instruction 155) add r1, r2, r3 (r2+r3→r1)

Here, the instructions 151, 152, and 154 do not have any data dependency among them, so that each tag column of these instructions is set to “◯”. On the other hand, the instructions 153 and 155 have data dependency between them, so that each tag column of these instructions is set to “X”.

Furthermore, when the instructions 151, 152, and 155 are executed in the processor 101, an addition and subtraction arithmetic logical unit (ALU) is used as their arithmetic unit. On the other hand, when the instructions 153 and 154 are executed, a multiplier (Mul) is used as their arithmetic element.

Likewise, as shown in FIG. 3B, as another example, the following instruction set 160 (instructions 161 to 165) is stored in the arithmetic operation control unit 113 (instruction hold unit 131) in an chronological order of decoding.

(Instruction 161) add r8, r13, r14 (r13+r14→r8)

(Instruction 162) mul r10, r11, r12 (r11*r12→r10)

(Instruction 163) mul r7, r8, r9 (r8*r9→r7)

(Instruction 164) mul r1, r5, r6, (r5*r6→r1)

(Instruction 165) add r1, r2, r3 (r2+r3→r1)

Here, the instructions 161, 162, and 164 do not have any data dependency among them, so that each tag column of these instructions is set to “◯”. On the other hand, the instructions 163 and 165 have data dependency between them, so that each tag column of these instructions is set to “X”.

Furthermore, when the instructions 161 and 165 are executed in the processor 101, an addition and subtraction arithmetic logical unit (ALU) is used as their arithmetic element. On the other hand, when the instructions 162 and 164 are executed, a multiplier (Mul) is used as their arithmetic element.

Moreover, as shown in FIG. 3C, for these cases, the arithmetic unit 115 includes the fixed function arithmetic element 121 (Add/Sub), the fixed function arithmetic element 122 (multiplier), and the fixed function arithmetic element (Ld/St). Furthermore, the arithmetic unit 115 includes the reconfigurable arithmetic element 125 in addition to the above fixed function arithmetic elements 121 to 123.

Here, the Add/Sub is the addition and subtraction arithmetic logical unit (ALU). The Mul is a multiplier. The Ld/St is a loader/storer (LD/ST).

For example, from among the instruction set 150 (for example, as shown in FIG. 3A), the arithmetic operation control unit 113 (instruction allocation unit 133) allocates the instruction 151, which has been decoded the earliest among the instructions 151 and 152 issue-able to the fixed function arithmetic element 121 (Add/Sub), to the fixed function arithmetic element 121 (Add/Sub). The arithmetic operation control unit 113 (instruction allocation unit 133) allocates the instruction 154 issue-able to the fixed function arithmetic element 122 (multiplier) to the fixed function arithmetic element 122 (multiplier). Since there is no instruction issue-able to the fixed function arithmetic element 123 (Ld/St), no instruction is allocated to the fixed function arithmetic element 123 (Ld/St). Further, the arithmetic operation control unit 113 (instruction allocation unit 133) allocates the instruction 152 issue-able to the reconfigurable arithmetic element 125 to the reconfigurable arithmetic element 125.

Furthermore, from among the instruction set 160 (for example, as shown in FIG. 3B), the arithmetic operation control unit 113 (instruction allocation unit 133) allocates the instruction 161 issue-able to the fixed function arithmetic element 121 (Add/Sub), to the fixed function arithmetic element 121 (Add/Sub). From among the instructions 162 and 164 issue-able to the fixed function arithmetic element 122 (multiplier), the arithmetic operation control unit 113 (instruction allocation unit 133) allocates the instruction 162 which has been decoded earlier to the fixed function arithmetic element 122 (multiplier). Since there is no instruction issue-able to the fixed function arithmetic element 123 (Ld/St), no instruction is allocated to the fixed function arithmetic element 123 (Ld/St). Further, the arithmetic operation control unit 113 (instruction allocation unit 133) allocates the instruction 164 issue-able to the reconfigurable arithmetic element 125 (Reconf) to the reconfigurable arithmetic element 125 (Reconf).

As above, the processor 101 according to the first embodiment can allocate an instruction to the reconfigurable arithmetic element 125. Thereby, even if the number of the fixed function arithmetic elements 121 and the like is restricted, the processor 101 according to the first embodiment can improve parallel execution of the instructions while reducing a circuit size.

### Second Embodiment

Next, the second embodiment according to the present invention is described with reference to the drawings.

The processor according to the second embodiment includes a configuration control unit which directs the reconfigurable arithmetic element to dynamically reconfigure a circuit configuration of the reconfigurable arithmetic element based on configuration information defining a circuit configuration compliant to two or more instructions. According to the control, in the processor according to the second embodiment, an instruction allocation unit allocates the two or more instructions to the reconfigurable arithmetic element at the same time, and an instruction issuing unit issues the two or more instructions to the reconfigurable arithmetic element in parallel.

Based on the above aspects, the processor according to the second embodiment is described below. It should be noted that the same numeral references in the processor according to the first embodiment are assigned to identical units and elements in the processor according to the second embodiment, and the description for the identical units and elements are not given again below.

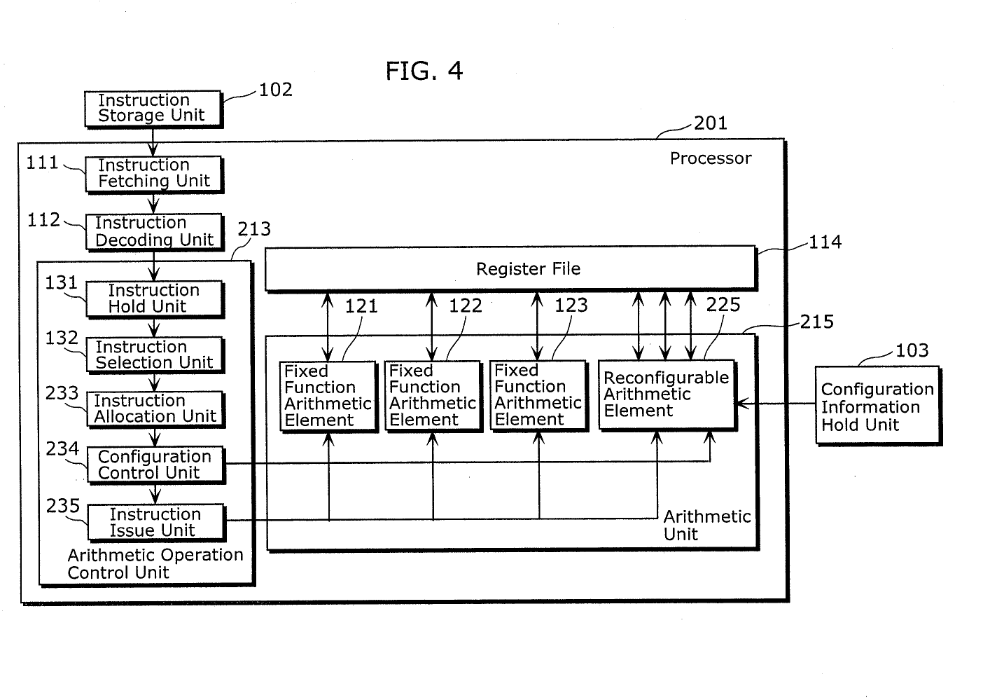

FIG. 4 is a diagram showing the structure of the processor according to the second embodiment. As shown in FIG. 4, the processor 201 differs from the processor 101 according to the first embodiment (refer to FIG. 1, for example) in the following aspects (1) and (2).

(1) The processor 201 includes an arithmetic operation control unit 213 instead of the arithmetic operation control unit 113.

The arithmetic operation control unit 213 (instruction allocation unit 233) can allocate two or more instructions to the reconfigurable arithmetic element 225 at the same time. Furthermore, the arithmetic operation control unit 213 (configuration control unit 234) dynamically reconfigure a circuit configuration of the reconfigurable arithmetic element 225 based on configuration information defining a circuit configuration compliant to two or more instructions. Then, the arithmetic operation control unit 213 (instruction issue unit 235) issues two or more instructions to the reconfigurable arithmetic element 225 in parallel. In other words, the arithmetic operation control unit 213 can allocate a plurality of instructions to the reconfigurable arithmetic element 225.

(2) The processor 201 includes an arithmetic unit 215 instead of the arithmetic unit 115.

The arithmetic unit 215 includes the reconfigurable arithmetic element 225 which can execute one or more instructions in parallel as far as a circuit size of the reconfigurable arithmetic element 225 permits, in stead of the reconfigurable arithmetic element 125 which executes only one instruction at the same time. In other words, the reconfigurable arithmetic element 225 can configure a circuit configuration by which n (n is a natural number) instructions at maximum can be executed in parallel. It should be noted that the reconfigurable arithmetic element 225 may function as: n kinds of arithmetic circuits; n arithmetic circuits of the same kind; or totally n arithmetic circuits of various kinds.

Here, the circuit size of the reconfigurable arithmetic element 225 is assumed to be a circuit size by which both of an adder/subtractor and a multiplier can be dynamically reconfigured at the same time although two multipliers cannot be dynamically reconfigured at the same time. Of course, the circuit size of the reconfigurable arithmetic element 225 is not limited to the above.

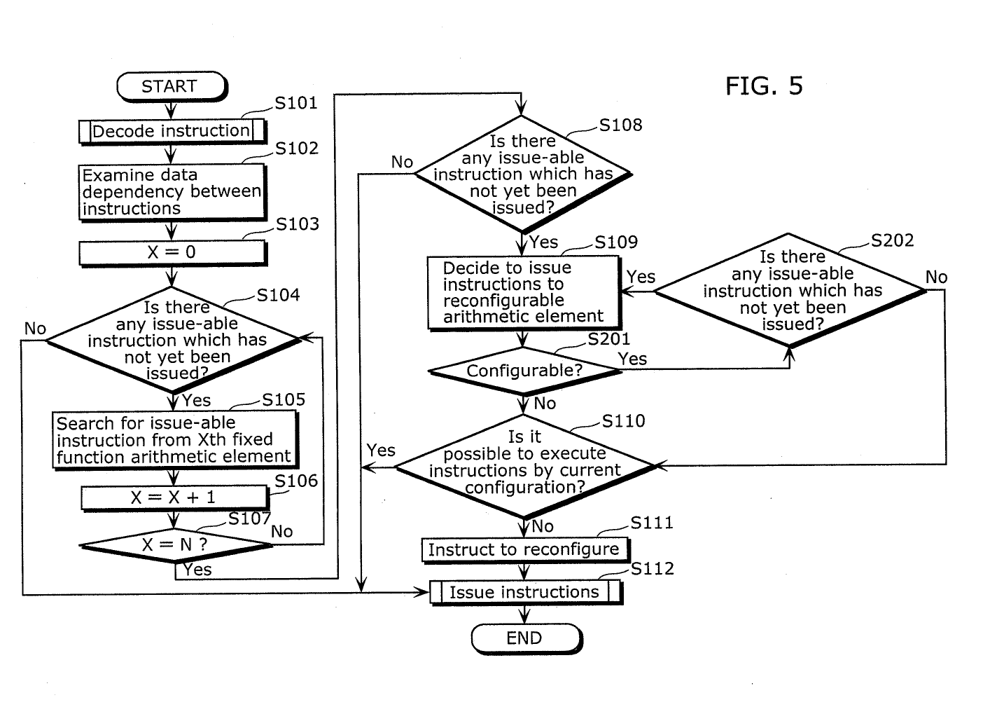

FIG. 5 is a flowchart of the processing performed by the processor according to the second embodiment of the present invention. As shown in FIG. 5, the arithmetic operation control unit 213 (instruction allocation unit 233) determines whether or not there is still any instruction which does not have any data dependency with another (S108), and if the determination is made that there is still an instruction which does not have any data dependency with another (Yes at S108), then, from among the instructions which do not have any data dependency among them, the arithmetic operation control unit 213 (instruction allocation unit 233) allocates instructions issue-able to the reconfigurable arithmetic element 225 except allocated instructions, to the reconfigurable arithmetic element 225 (S109, S201, S202). Here, the searched instructions are allocated in an chronological order of decoding.

Then, the arithmetic operation control unit 213 (configuration control unit 234) determines whether or not the instructions allocated to the reconfigurable arithmetic element 225 can be executed by a current circuit configuration of the reconfigurable arithmetic element 225 (S110). If the determination is made that the instructions cannot be executed by the current circuit configuration of the reconfigurable arithmetic element 225, then the arithmetic operation control unit 213 (configuration control unit 234) directs the reconfigurable arithmetic element 225 to reconfigure the current circuit configuration (S111).

On the other hand, if the determination is made that there is no instruction which does not have any data dependency with another (No at S202), then the arithmetic operation control unit 213 (instruction allocation unit 233) determines whether or not the instructions scheduled to the reconfigurable arithmetic element 225 can be executed by a current circuit configuration of the reconfigurable arithmetic element 225 (S110).

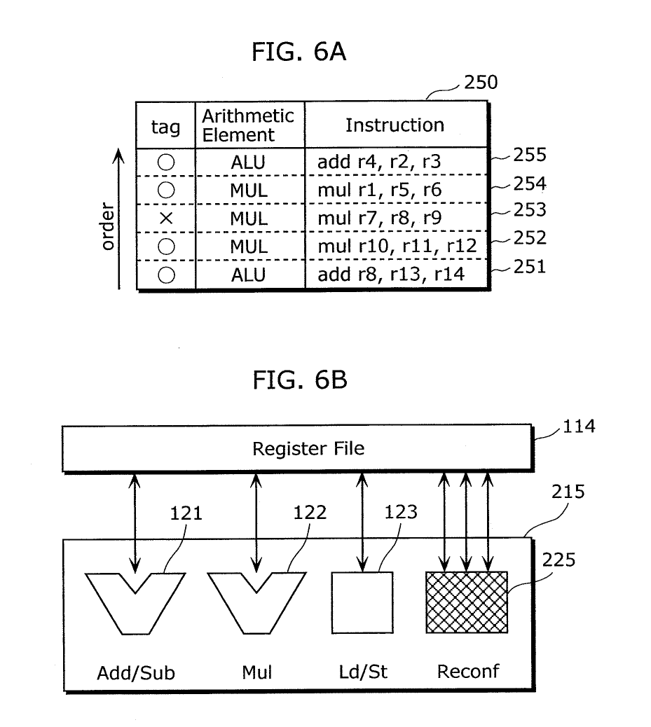

FIG. 6A is a table showing an instruction set executed by the processor according to the second embodiment. FIG. 6B is a diagram showing structures of the arithmetic elements in the arithmetic unit of the processor according to the second embodiment. Here, as one example, as shown in FIG. 6A, the following instruction set 250 (instructions 251 to 255) is stored in the arithmetic operation control unit 213 (instruction hold unit 131) in an chronological order of decoding.

(Instruction 251) add r8, r13, r14 (r13+r14→r8)

(Instruction 252) mul r10, r11, r12 (r11*r12→r10)

(Instruction 253) mul r7, r8, r9 (r8*r9→r7)

(Instruction 254) mul r1, r5, r6, (r5*r6→r1)

(Instruction 255) add r4, r2, r3 (r2+r3→r4)

Here, the instructions 251, 252, 254, and 255 do not have any data dependency among them, so that each tag column of these instructions is set to “◯”. On the other hand, the instruction 253 has data dependency with another instruction, so that a tag column of the instruction 253 is set to “X”.

Furthermore, when the instructions 251 and 255 are executed in the processor 201, an addition and subtraction arithmetic logical unit (ALU) is used as their arithmetic element. On the other hand, when the instructions 252 to 254 are executed, a multiplier (Mul) is used as their arithmetic element.

Here, as shown in FIG. 6B, in this case, the arithmetic unit 215 has the reconfigurable arithmetic element 225 which can dynamically reconfigure a plurality of arithmetic elements at the same time as far as a circuit size permits, in stead of the reconfigurable arithmetic element 125.

For example, from among the instruction set 250 (for example, as shown in FIG. 6A), the arithmetic operation control unit 213 (instruction allocation unit 233) allocates the instruction 251, which has been decoded earlier among the instructions 251 and 255 issue-able to the fixed function arithmetic element 121 (Add/Sub), to the fixed function arithmetic element 121 (Add/Sub). From among the instructions 252 and 254 issue-able to the fixed function arithmetic element 122 (multiplier), the arithmetic operation control unit 213 (instruction allocation unit 233) allocates the instruction 252 which has been decoded earlier to the fixed function arithmetic element 122 (multiplier). Since there is no instruction issue-able to the fixed function arithmetic element 123 (Ld/St), no instruction is allocated to the fixed function arithmetic element 123 (Ld/St). Further, from among the instructions 251, 252, 254, and 255 without data dependency except the already-allocated instructions 251 and 252, the arithmetic operation control unit 213 (instruction allocation unit 233) allocates a plurality of instructions from among the instructions 254 and 255 issue-able to the reconfigurable arithmetic element 225 (Reconf), to the reconfigurable arithmetic element 225 (Reconf) as far as a circuit size permits. Here, since the reconfigurable arithmetic element 225 can be dynamically reconfigured to function as an adder/subtractor (ALU) and a multiplier (Mul) at the same time, both of the instructions 254 and 255 are allocated to the reconfigurable arithmetic element 225.

As above, the processor 201 according to the second embodiment can allocate a plurality of instructions to the reconfigurable arithmetic element 225. Thereby, even if the number of the fixed function arithmetic elements is restricted, the processor 201 according to the second embodiment can improve parallel execution of the instructions while reducing a circuit size.

### Third Embodiment

Next, the third embodiment according to the present invention is described with reference to the drawings.

The processor according to the third embodiment includes: a configuration control unit which inserts a configuration instruction prior to a predetermined instruction, the configuration instruction instructing the reconfigurable arithmetic element to reconfigure the circuit configuration; and an instruction issuing unit which issues the predetermined instruction after issuing the configuration instruction.

Based on the above aspects, the processor according to the third embodiment is described below. It should be noted that the same numeral references in the processor according to the first embodiment are assigned to identical units and elements in the processor according to the third embodiment, and the description for the identical units and elements are not given again below.

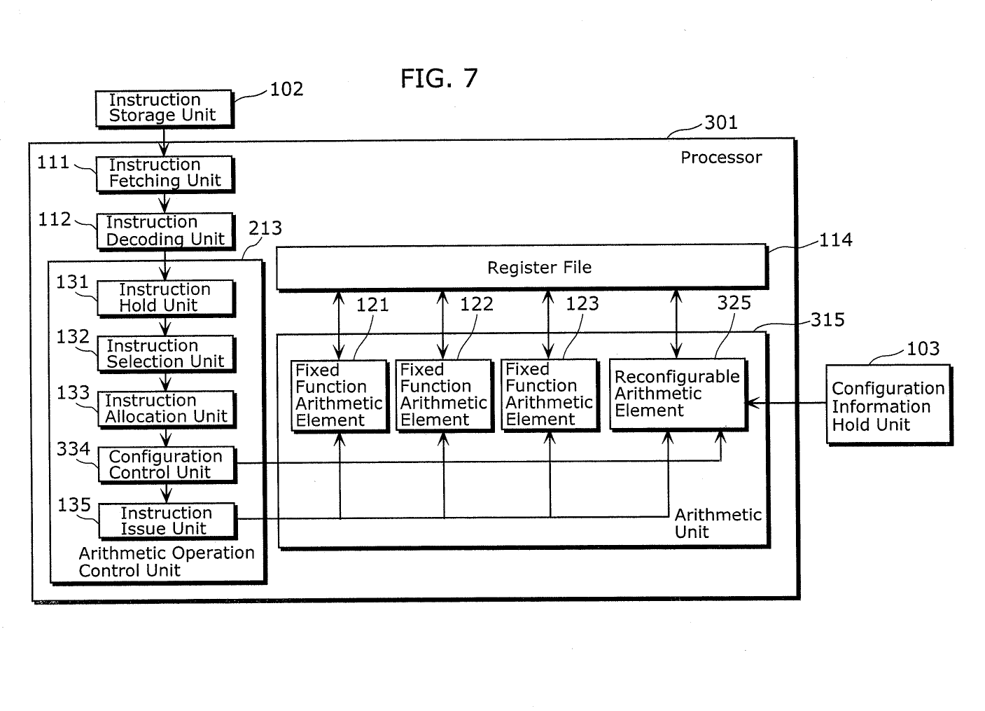

FIG. 7 is a diagram showing the processor according to the third embodiment. As shown in FIG. 7, the processor 301 differs from the processor 101 according to the first embodiment (refer to FIG. 1, for example) in the following aspects (1) and (2).

(1) The processor 301 includes an arithmetic operation control unit 313 instead of the arithmetic operation control unit 113.

If a circuit configuration of the reconfigurable arithmetic element 325 to which a predetermined instruction is allocated is not compliant to the predetermined instruction, the arithmetic operation control unit 313 (configuration control unit 334) directs the reconfigurable arithmetic element 325 to dynamically reconfigure the circuit configuration based on configuration information defining a circuit configuration compliant to the predetermined instruction.

Here, prior to issuing of the predetermined instruction to the reconfigurable arithmetic element 325, the arithmetic operation control unit 313 (instruction issue unit 335) issues the second instruction (hereinafter, referred to as a “configuration instruction”) for instructing to reconfigure the circuit configuration of the reconfigurable arithmetic element 325, to the reconfigurable arithmetic element 325.

More specifically, in the case where the reconfigurable arithmetic element 325 cannot execute the predetermined instruction even if received because the circuit configuration of the reconfigurable arithmetic element 325 is not compliant to the predetermined instruction, the arithmetic operation control unit 313 (i) issues an alternative configuration instruction to the reconfigurable arithmetic element 325 to reconfigure its circuit configuration, (ii) causing the circuit configuration to be reconfigured during the issuing, and (iii) issues the predetermined instruction after the reconfiguring.

(2) The processor 301 includes an arithmetic unit 315 instead of the arithmetic unit 115.

The arithmetic unit 315 includes the reconfigurable arithmetic element 325 instead of the reconfigurable arithmetic element 125. The reconfigurable arithmetic element 325 destroys configuration instructions without any operations, even if the configuration instructions are received.

It should be noted that the reconfigurable arithmetic element 325 may reconfigure the circuit configuration according to the configuration instruction, instead of reconfiguring the circuit configuration according to the direction from the configuration control unit 334.

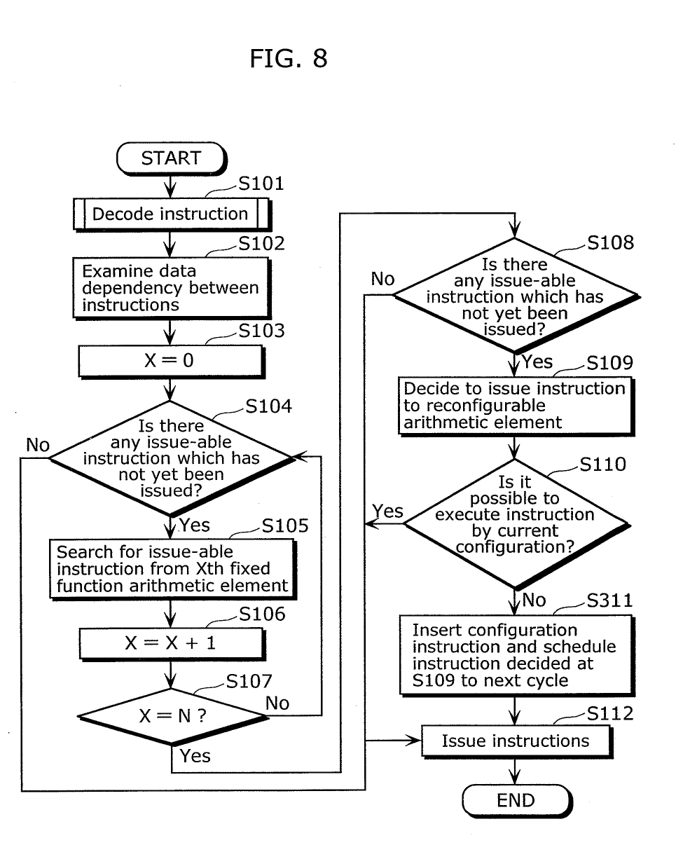

FIG. 8 is a flowchart of the processing performed by the processor according to the third embodiment of the present invention. As shown in FIG. 8, if an instruction issue-able to the reconfigurable arithmetic element 325 cannot be executed by a current circuit configuration of the reconfigurable arithmetic element 325 (No at S110), then the arithmetic operation control unit 313 (instruction issue unit 335) issues a configuration instruction to the reconfigurable arithmetic element 325 instead of the instruction, and issues the instruction in a next cycle as a priority (S311).

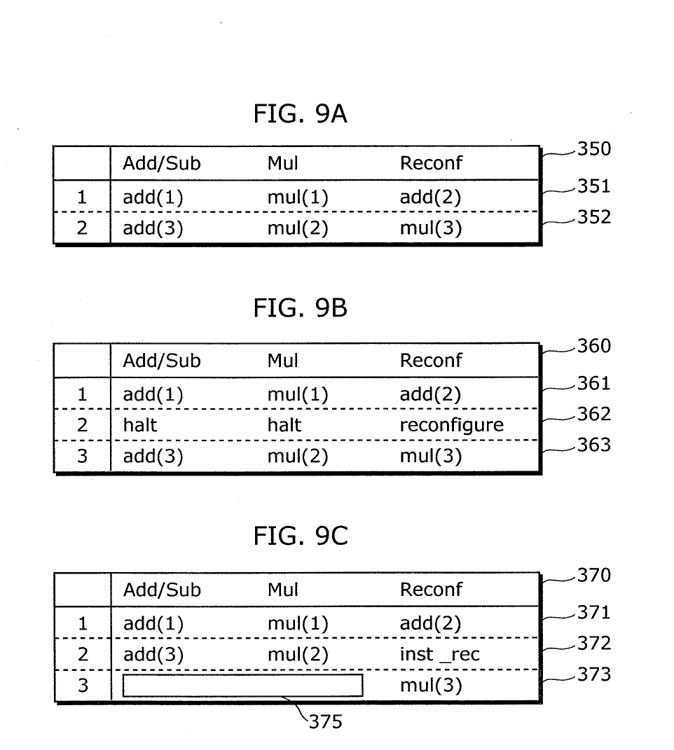

FIG. 9A is a table showing an instruction set executed by the processor according to the third embodiment. FIG. 9B is a table showing one processing example of the case where a configuration instruction is not inserted into an instruction set executed by the processor according to the third embodiment of the present invention. FIG. 9C is a table showing one processing example of the case where a configuration instruction is inserted into an instruction set executed by the processor according to the third embodiment of the present invention. Here, as one example, as shown in FIG. 9A, the description is given for the case of the following instruction sets 351 and 352.

The instruction set 351 is consisted of an instruction add(1) allocated to the fixed function arithmetic element 121 (adder/subtractor), an instruction mul(1) allocated to the fixed function arithmetic element 122 (multiplier), and an instruction add(2) allocated to the reconfigurable arithmetic element 325 (reconfigurable arithmetic element).

The instruction set 352 is consisted of an instruction add(3) allocated to the fixed function arithmetic element 121 (adder/subtractor), an instruction mul(2) allocated to the fixed function arithmetic element 122 (multiplier), and an instruction mul(3) allocated to the reconfigurable arithmetic element 325 (Reconf).

Conventionally, these instructions have actually been executed at Steps 361 to S363 of FIG. 9B. Here, there is an overhead at Step 362.

At Step 361, to the fixed function arithmetic element 121 (adder/subtractor) the instruction add(1) is issued, to the fixed function arithmetic element 122 (multiplier) the instruction mul(1) is issued, and to the reconfigurable arithmetic element 325 (Reconf) the instruction add(2) is issued.

At Step 362, to the fixed function arithmetic element 121 (adder/subtractor) an instruction “halt” is issued, to the fixed function arithmetic element 122 (multiplier) an instruction “halt” is issued, and to the reconfigurable arithmetic element 325 (Reconf) an instruction “reconfigure” is issued.

At Step 363, to the fixed function arithmetic element 121 (adder/subtractor) the instruction add(3) is issued, to the fixed function arithmetic element 122 (multiplier) the instruction mul(2) is issued, and to the reconfigurable arithmetic element 325 (Reconf) the instruction mul(3) is issued.

On the other hand, as shown in FIG. 9C, the arithmetic operation control unit 313 (instruction issue unit 335) issues the instructions in parallel in the following cycles 371 to 373.

In Cycle 371, in parallel, to the fixed function arithmetic element 121 (adder/subtractor) the instruction add(1) is issued, to the fixed function arithmetic element 122 (multiplier) the instruction mul(1) is issued, and to the reconfigurable arithmetic element 325 (Reconf) the instruction add(2) is issued.

In Cycle 372, in parallel, to the fixed function arithmetic element 121 (adder/subtractor) the instruction add(3) is issued, to the fixed function arithmetic element 122 (multiplier) the instruction mul(2) is issued, and to the reconfigurable arithmetic element 325 (Reconf) an instruction inst_rec(mul) is issued. Here, the instruction inst_rec(mul) is an instruction for directing to reconfigure the reconfigurable arithmetic element 325 to a multiplier (Mul).

In cycle 373, to the reconfigurable arithmetic element 325 which has been reconfigured, the instruction mul(3) is issued. Here, by allocating instructions to the fixed function arithmetic element 121 (adder/subtractor) and the fixed function arithmetic element 122 (multiplier), efficiency of the instruction issuing is improved.

As above, the processor 301 according to the third embodiment issues the configuration instruction to the reconfigurable arithmetic element 325 prior to issuing of a predetermined instruction, when the circuit configuration of the reconfigurable arithmetic element 325 is to be reconfigured according to allocation of the predetermined instruction to the reconfigurable arithmetic element 325. Thereby, it is possible to issue instructions allocated to the fixed function arithmetic elements in parallel to the issuing of the configuration instruction, although the reconfiguring takes a time. In other words, it is possible to prevent the situation where the instructions allocated to the fixed function arithmetic elements should also be waited for being issued together with the predetermined instruction until the completion of the reconfiguring.

### Fourth Embodiment

Next, the fourth embodiment according to the present invention is described with reference to the drawings.

The information processing apparatus including the processor according to any one of the embodiments, the information processing apparatus including: (a) a configuration information hold unit operable to hold configuration information defining an optimum circuit configuration for a software program to be executed; (b) an instruction storage unit in which an instruction code in an executable format is stored, the instruction code being generated based on a circuit configuration of the processor, and the circuit configuration of the processor being decided from the configuration information, and (c) a configuration control unit operable to direct the reconfigurable arithmetic element to reconfigure a circuit configuration of the reconfigurable arithmetic element based on the configuration information, prior to directing the processor to execute the instruction code.

Furthermore, the information processing apparatus may further include: (a) a template holding unit operable to hold a plural kinds of configuration information templates of the configuration information; (b) a software program holding unit operable to hold a plurality of software programs; (c) a software program decision unit operable to decide the software program to be executed, from among the plurality of software programs; (d) a template selection unit operable to select an optimum configuration information template for the software program to be executed, from among the plural kinds of configuration information templates; (e) a circuit configuration temporary decision unit operable to temporarily decide the circuit configuration of the processor, based on the optimum configuration information template selected by the template selection unit; (f) an instruction code generation unit operable to generate the instruction code in the executable format from the software program decided by the software program decision unit, based on the circuit configuration temporality decided by the circuit configuration temporary decision unit; (g) a threshold value determination unit operable to determine whether or not an execution cycle for the instruction code generated by the instruction code generation unit is equal to or less than a threshold value; and (h) an output unit operable to output the instruction code generated by the instruction code generation unit to the instruction storage unit, and the optimum configuration information template selected by the template selection unit to the configuration information hold unit, when the determination is made that the execution cycle is equal to or less than the threshold value.

Based on the above aspects, the processor according to the fourth embodiment is described below. It should be noted that the same numeral references in the processor according to the first embodiment are assigned to identical units and elements in the fourth embodiment, and the description for the identical units and elements are not given again below.

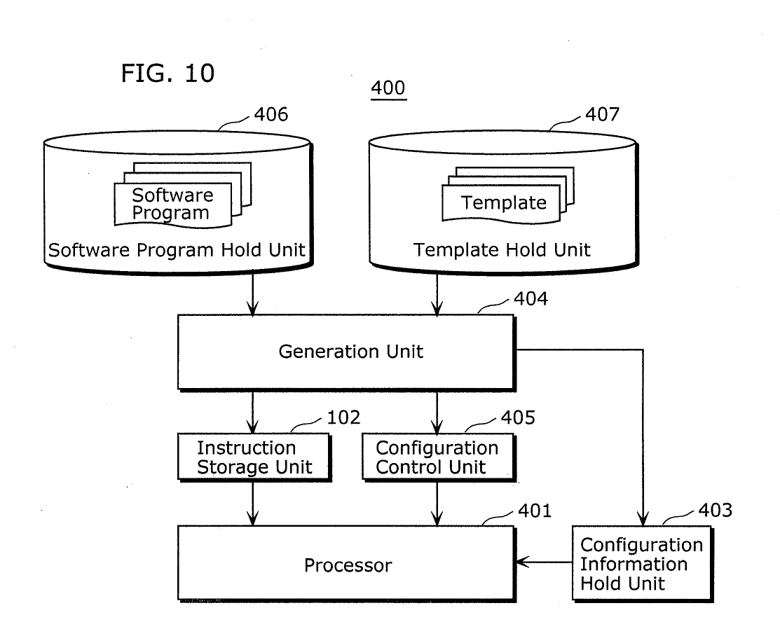

FIG. 10 is a diagram showing a structure of the information processing apparatus in which the processor according to any one of the embodiments is embedded. As shown in FIG. 10, the information processing apparatus 400 includes a processor 401, the instruction storage unit 102, a configuration information hold unit 403, a generation unit 404, a configuration control unit 405, a software program hold unit 406, and a template hold unit 407. Here, the generation unit 404 includes at least the software program decision unit, the template selection unit, the circuit configuration temporary decision unit, the instruction code generation unit, the threshold value determination unit, and the output unit. Further, the information processing apparatus 400 includes at least the processor and a memory which are connected with each other via an internal bus.

The processor 401 reads out optimization codes stored in the instruction storage unit 102, and executes the optimization code.

The instruction storage unit 102 stores the optimization codes provided from the generation unit 404.

The configuration information hold unit 403 holds, as pieces of the configuration information, templates of configuration information (configuration information templates) provided from the generation unit 404. Here, in each configuration information template, one or more arithmetic circuits are defined. It should be noted that the configuration information hold unit 403 may be embedded in the processor 401.

The generation unit 404 decides a software program to be executed, from among a plurality of software programs. Then, the generation unit 404 selects an optimum template for the decided software program from the various kinds of configuration information templates. Here, the plurality of software programs are held in the software program hold unit 406. The various kinds of configuration information templates are held in the template hold unit 407.

Furthermore, the generation unit 404 temporarily decides a circuit configuration of the processor 401 (hereinafter, referred to as an “architecture”) based on the selected template. Based on the temporarily decided architecture, the decided software program is optimized, thereby generating an instruction code in a final execution format (hereinafter, referred to as an “optimization code”). If the generated optimization code satisfies target efficiency, in other words, if an execution cycle of the generated optimization code is equal to or less than a predetermined threshold value, the generation unit 404 outputs the generated optimization code to the instruction storage unit 102, and outputs the selected configuration information template to the configuration information hold unit 403. On the other hand, if the generated optimization code does not satisfy the target efficiency, in other words, if the execution cycle exceeds the threshold value, a next configuration information template which is except the template selected by the generation unit 404 is selected and the above processing is repeated.

Here, if the generation unit 404 have selected all of the configuration information templates, the generation unit 404 chooses a configuration information template having a minimum execution cycle from among the selected configuration information templates. An optimization code generated using the selected configuration information template is provided to the instruction storage unit 102, and the chosen configuration information template is provided to the configuration information hold unit 403. Here, until the selected configuration information template is provided to the configuration information hold unit 403, the generation unit 404 is assumed to hold execution cycles and optimization codes of the respective selected configuration information templates.

It should be noted that, in order to evaluate an execution cycle of the generated optimization code, the generation unit 404 may simulate the processor 401 or actually operate the processor 401.

The configuration control unit 405 directs a reconfigurable arithmetic element 425 to reconfigure a circuit configuration of the reconfigurable arithmetic element 425 based on the configuration information held in the configuration information hold unit 403, prior to directing the processor 401 to execute the optimization code held in the instruction storage unit 102. It should be noted that the configuration control unit 405 may be embedded in the processor 401.

The software program hold unit 406 holds a plurality of software programs.

The template hold unit 407 holds the various kinds of configuration information templates.

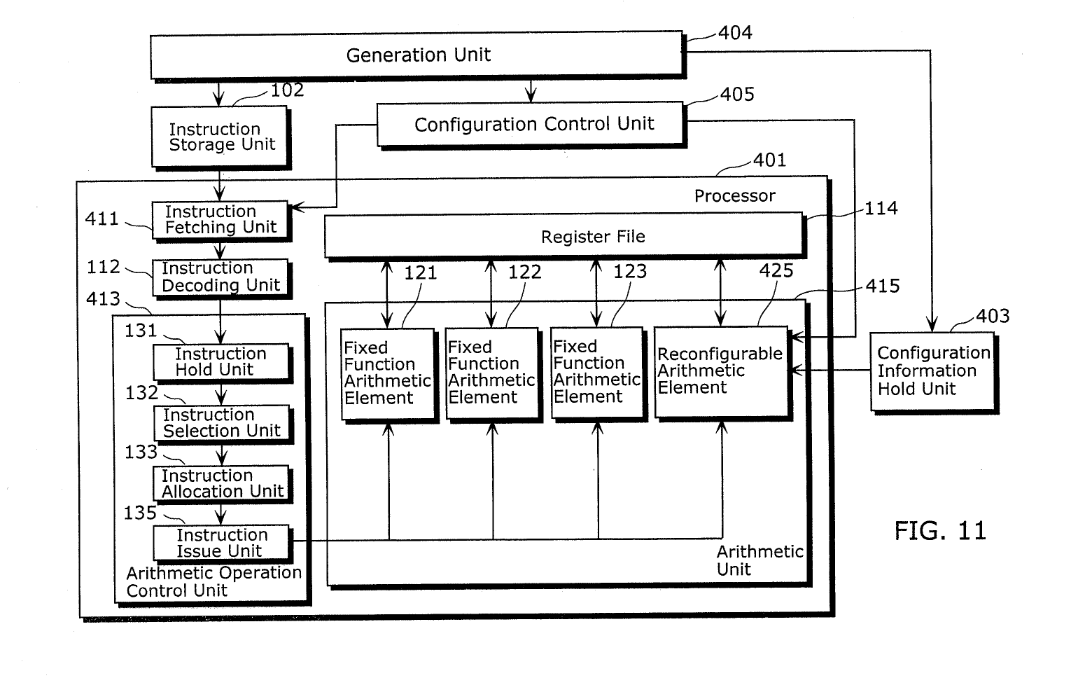

FIG. 11 is a diagram showing a structure of the processor according to the fourth embodiment. As shown in FIG. 11, the processor 401 differs from the processor 101 according to the first embodiment (refer to FIG. 1, for example) in the following aspects (1) to (3).

(1) The processor 401 includes an instruction fetching unit 411 instead of the instruction fetching unit 111.

When the configuration control unit 405 directs the instruction fetching unit 411 to execute an optimization code of a software program to be executed, the instruction fetching unit 411 reads out the optimization code of the software program to be executed from the instruction storage unit 102.

(2) The processor 401 includes an arithmetic operation control unit 413 instead of the arithmetic operation control unit 113.

The arithmetic operation control unit 413 does not have the configuration control unit 134, because the arithmetic operation control unit 413 reconfigures a circuit configuration of the reconfigurable arithmetic element 425 not for each instruction, but for each software program. During executing a software program, an instruction compliant to a circuit configuration of the reconfigurable arithmetic element 425 which has been reconfigured prior to the executing is allocated and issued to the reconfigurable arithmetic element 425.

(3) The processor 401 includes an arithmetic unit 415 instead of the arithmetic unit 115.

The arithmetic unit 415 includes the reconfigurable arithmetic element 425 instead of the reconfigurable arithmetic element 125. When the configuration control unit 405 directs the reconfigurable arithmetic element 425 to reconfigure a circuit configuration of the reconfigurable arithmetic element 425, the reconfigurable arithmetic element 425 reconfigures the circuit configuration based on configuration information corresponding to a software program to be executed. Here, if the reconfiguration is performed based on configuration information defining a plurality of arithmetic circuits, the reconfigurable arithmetic element 425 executes, in parallel, a plurality of instructions executable by the reconfigured circuit configuration.

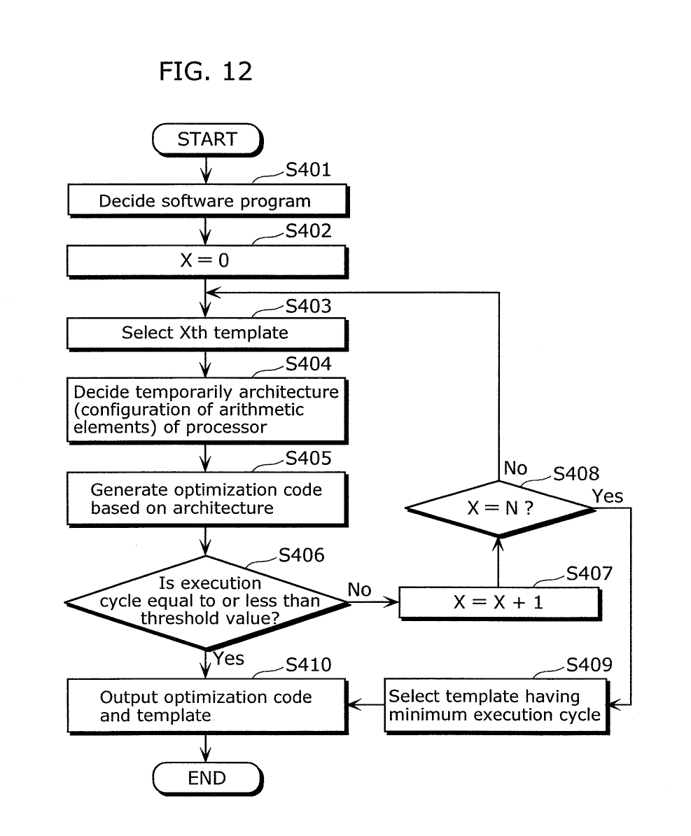

FIG. 12 is a flowchart of one example of processing performed by the generation unit according to the fourth embodiment. As shown in FIG. 12, the generation unit 404 decides a software program to be executed, from among a plurality of software programs (S401). An optimum template for the decided software program is selected from the various kinds of configuration information templates (S402, S403). Based on the selected template, an architecture (configuration of the arithmetic unit) of the processor 401 is temporarily decided (S404). Based on the temporarily decided architecture (configuration of the arithmetic unit), an optimization code is generated from the selected software program (S405). If the generated optimization code satisfies target efficiency, in other words, if an execution cycle of the generated optimization code is equal to or less than a predetermined threshold value (Yes at S406), then the generated optimization code is provided to the instruction storage unit 102, and the selected template is provided to the configuration information hold unit 403 (S410). On the other hand, if the generated optimization code does not satisfy the target efficiency, in other words, if the execution cycle exceeds the threshold value (No at S406), then a next template is selected (S407) and the above processing is repeated (No at S408).

Here, if the generation unit 404 has selected all of the templates (Yes at S408), then the generation unit 404 chooses a template having a minimum execution cycle from among the selected templates (S409). An optimization code generated using the chosen template is provided to the instruction storage unit 102, and the chosen template is provided to the configuration information hold unit 403 (S410).

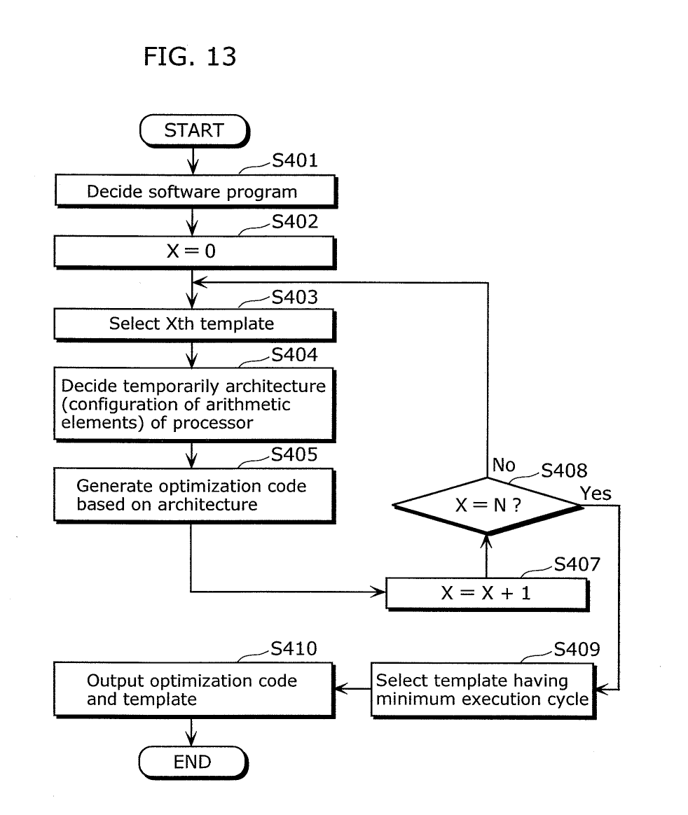

It should be noted that, as shown in FIG. 13, Step S406 may be eliminated.

As described above, the information processing apparatus 400 in which the processor 401 according to the fourth embodiment is embedded directs to reconfigure a circuit configuration not for each instruction, but for each software program. Thereby, the reconfiguration of circuit configuration is not performed during executing a software program, which can reduce power consumption resulting from the reconfiguration of circuit configuration. In addition, in the case where the reconfiguration of circuit configuration takes a time, it is possible to prevent the status of waiting for instruction issuing which results from the reconfiguration. In short, according to the fourth embodiment, the parallel execution of the instruction can be improved while reducing a circuit size. Moreover, the power consumption can be reduced.

### Fifth Embodiment

Next, the fifth embodiment according to the present invention is described with reference to the drawings.

The information processing apparatus, (a) when the plurality of software programs are to be executed by time-sharing, may further includes (b) a switch unit operable to switch the software program to be executed to another for each predetermined time period, (c) wherein the configuration information hold unit is operable to hold the configuration information for each of the plurality of software programs, (d) the instruction storage unit is operable to hold the instruction code for each of the plurality of software programs, and (e) the configuration control unit is operable to direct the reconfigurable arithmetic element to reconfigure the circuit configuration of the reconfigurable arithmetic element, every time the software program to be executed is switched to another.

Based on the above aspects, the information processing apparatus according to the fifth embodiment is described below. It should be noted that the same numeral references in the information processing apparatus according to the fourth embodiment are assigned to identical units and elements in the information processing apparatus according to the fifth embodiment, and the description for the identical units and elements are not given again below

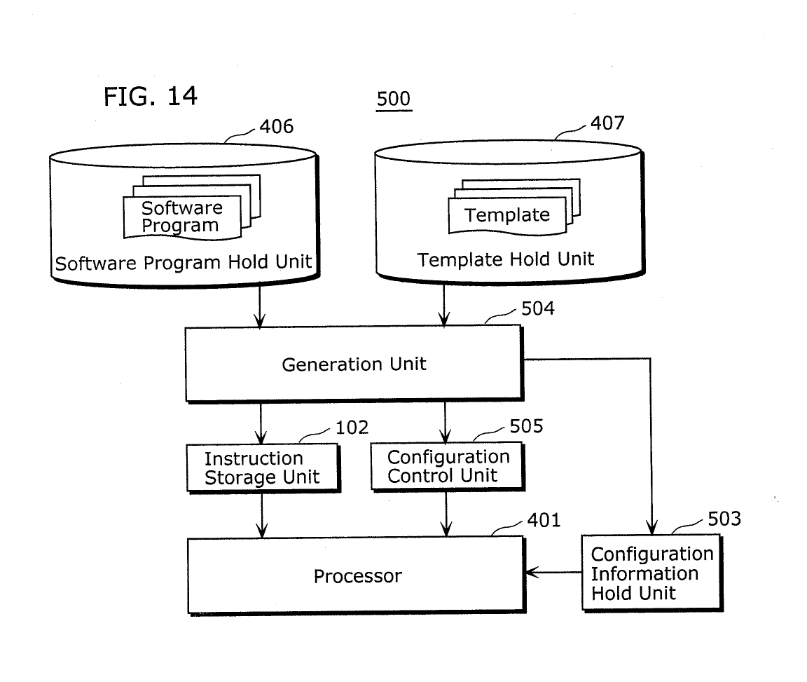

FIG. 14 is a diagram showing a structure of the information processing apparatus according to the fifth embodiment. As shown in FIG. 14, the information processing apparatus 500 executes, by time-sharing, a plurality of software programs held in a software program hold unit 506. Here, every time a software program to be executed is switched to another, a circuit configuration of the reconfigurable arithmetic element 425 (refer to FIG. 11, for example) is reconfigured. Moreover, a generation unit 504 includes a switch unit.

In more detail, the generation unit 504 previously generates an optimization code for each software program. The generated optimization code is provided to the instruction storage unit 102. In addition, the generation unit 504 selects an optimum configuration information template for each software program from various kinds of configuration information templates. The selected configuration information template is provided to a configuration information hold unit 503. It should be noted that the configuration information hold unit 503 may be embedded in the processor 401.

Here, for each software program, the optimization code provided from the generation unit 504 is stored in the instruction storage unit 102. Furthermore, for each software program, the configuration information template provided from the generation unit 504 is held in the configuration information hold unit 503 as configuration information.

It is preferable that a configuration information template optimum for a software program is selected by the technique described for the fourth embodiment.

Then, every time a software program to be executed is switched to another, the configuration control unit 505 directs the reconfigurable arithmetic element 425 to reconfigure a circuit configuration of the reconfigurable arithmetic element 425 based on the configuration information corresponding to the software program to be executed. In addition, the configuration control unit 505 directs the processor 401 to execute an optimization code of the software program to be executed. In response to the directing, the processor 401 reads out the optimization code of the software program to be executed from the instruction storage unit 102, and executes the read-out optimization code. It should be noted that the configuration control unit 505 may be embedded in the processor 401.

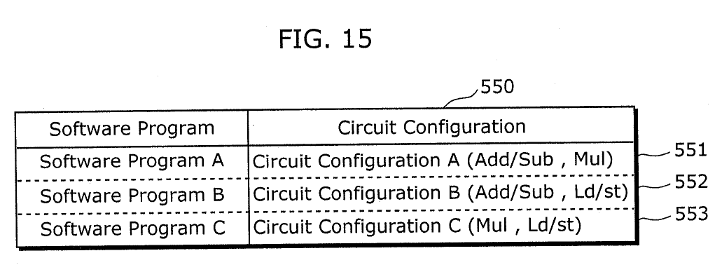

FIG. 15 is a table showing circuit configurations in associated with software programs to be executed in the processor according to the fifth embodiment. Here, as one example, as shown in FIG. 15, when an optimization code of a software program A is to be generated, the generation unit 504 selects a template in which a circuit configuration A (Add/Sub, Mul) is defined, from a plurality of templates. Likewise, when an optimization code of a software program B is to be generated, the generation unit 504 selects a template in which a circuit configuration B (Add/Sub, Ld/St) is defined, from the plurality of templates. When an optimization code of a software program C is to be generated, the generation unit 504 selects a template in which a circuit configuration C (Mul, Ld/St) is defined, from the plurality of templates.

According to the selecting, when the software program A is to be executed, the configuration control unit 505 which holds a table 550 directs the reconfigurable arithmetic element 425 to reconfigure the circuit configuration of the reconfigurable arithmetic element 425 to the circuit configuration A based on the held table 550. When the software program B is to be executed, the configuration control unit 505 directs the reconfigurable arithmetic element 425 to reconfigure the circuit configuration to the circuit configuration B. When the software program C is to be executed, the configuration control unit 505 directs the reconfigurable arithmetic element 425 to reconfigure the circuit configuration to the circuit configuration C.

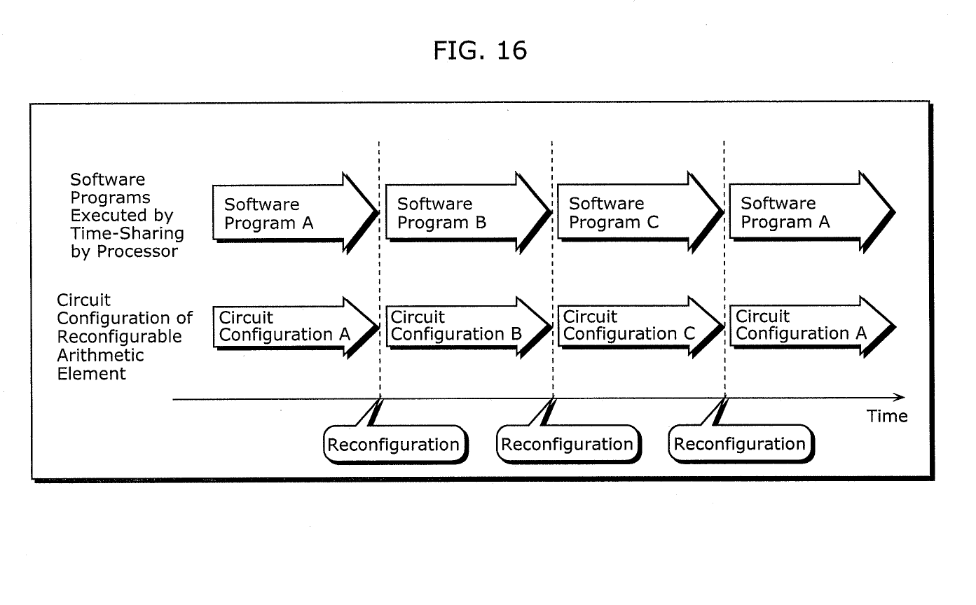

FIG. 16 is a graph showing one example of the case where a plurality of software programs are executed by time-sharing by the information processing apparatus according to the fifth embodiment. As shown in FIG. 16, every time a software program to be executed is switched to another, the configuration control unit 505 directs the reconfigurable arithmetic element 425 to reconfigure the circuit configuration of the reconfigurable arithmetic element 425.

For example, when a software program to be executed is switched from the software program A to the software program B, the configuration control unit 505 directs the reconfigurable arithmetic element 425 to reconfigure the circuit configuration from the circuit configuration A to the circuit configuration B. Likewise, when a software program to be executed is switched from the software program B to the software program C, the configuration control unit 505 directs the reconfigurable arithmetic element 425 to reconfigure the circuit configuration from the circuit configuration B to the circuit configuration C. When a software program to be executed is switched from the software program C to the software program A, the configuration control unit 505 directs the reconfigurable arithmetic element 425 to reconfigure the circuit configuration from the circuit configuration C to the circuit configuration A.

As described above, when a plurality of software programs are executed by time-sharing, the information processing apparatus according to the fifth embodiment directs the reconfigurable arithmetic element to reconfigure a circuit configuration of the reconfigurable arithmetic element, by switching software programs to be executed. In response to the directing, the reconfigurable arithmetic element 425 reconfigures its circuit configuration to the configuration indicated in the configuration information corresponding to the software program. Thereby, the information processing apparatus according to the fifth embodiment can shorten a total time period for operating software programs.

It should be noted that the generation unit 504 according to the fifth embodiment has been described to select the configuration information template for each software program, but the configuration information template may be selected for each thread.

It should also be noted that the configuration control unit 505 according to the fifth embodiment has been described to directs the reconfigurable arithmetic element 425 to reconfigure a circuit configuration of the reconfigurable arithmetic element 425 for each software program, but the configuration control unit 505 may instruct the reconfigurable arithmetic element 425 to reconfigure the circuit configuration for each thread.

### (Other Modifications)

It should be noted that the fixed function arithmetic elements and the reconfigurable arithmetic element according to any one of the above embodiments may be implemented into a single device, or that each of the elements may be implemented as an individual device.

When these elements are implemented into a single device, the device includes a part having a circuit configuration which is not dynamically rewritable and a part having a circuit configuration which is dynamically rewritable. In this case, the fixed function arithmetic elements are formed in the part having a circuit configuration which is not dynamically rewritable, and the reconfigurable arithmetic element is formed in the part having a circuit configuration which is dynamically rewritable.

When each of the elements is implemented as an individual device, the fixed function arithmetic element is implemented as a device having a circuit configuration which is not dynamically rewritable, and the reconfigurable arithmetic element is implemented as a device having a circuit configuration which is dynamically rewritable. Here, the device having a circuit configuration which is not dynamically rewritable may be a programmable logic device such as an semi-custom integrated circuit including a Large Scale Integration (LSI) and an Application Specific Integrated Circuit (ASI), a Field Programmable Gate Array (FPGA), a Complex Programmable Logic Device (CPLD), or the like. On the other hand, as the device having a circuit configuration which is dynamically rewritable, the reconfigurable arithmetic element may be implemented as a dynamic reconfigurable device having a circuit configuration which is dynamically rewritable or the like.

It should also be noted that a design data for implementing one or more functions in the information processing apparatus may be a program (hereinafter, referred to as an “HDL program”) described in a hardware description language such as a Very high speed integrated circuit Hardware Description Language (VHDL), a Verilog-HDL, a SystemC, or the like. Here, the design data may be a net list of a gate level which is generated by performing logic synthesis on the HDL program. Moreover, the design data may be macrocell information in which the net list of a gate level is added with arrangement information, process conditions, and the like. It is also possible that the design data is a mask data for defining a size, a timing, and the like. It should also be noted that the configuration information may be a net list of a gate level which is generated by performing logic synthesis on an HDL program in which one or more arithmetic circuits are described.

It should further be noted that the design data or the configuration information may be recorded on a recording medium such as an optical recording medium (CD-ROM, for example), a magnetic recording medium (hard disk, for example), a magnetooptical recording medium (MO, for example), a semiconductor memory (SD memory, for example), or the like, so that the design data or the configuration information can read out from the recording medium to the information processing apparatus according to the present invention.

It also possible to hold the design data or the configuration information in a hardware system on a transmission path such as a network, so that the design data or the configuration information can be obtained via the transmission path.

It should still further be noted that the processor according to the present invention may be embedded not only in the information processing apparatus, but also in a built-in system such as a digital TV, a digital recorder, a game machine, an IP telephone, a mobile telephone, a network apparatus, or the like. The processor according to the present invention may also be embedded in a computer system having a Central Processing Unit (CPU), a Random Access Memory (RAM), a Read Only Memory (ROM), a Hard Disk Drive (HDD), a network adaptor, or the like.

It should still further be noted that the processor according to the present invention has been described as a single-core processor, but the processor may be a multi-core processor. In this case, the reconfigurable arithmetic element may be shared.

It should still further be noted that the information processing apparatus according to the present invention has been described to include a single processor, but the information processing apparatus may include multiple processors.

### INDUSTRIAL APPLICABILITY

The present invention is used as a processor which processes digitalized video and/or audio, and more particularly as a signal processing processor which is embedded in a video device or an audio device using digital signals, such as a DVD recorder or a digital TV.

1. A processor in which a plurality of arithmetic elements that execute instructions are embedded, said processor comprising:
a fixed function arithmetic element having a circuit configuration which is not dynamically reconfigurable;
a reconfigurable arithmetic element having a circuit configuration which is dynamically reconfigurable;
an instruction allocation unit operable to allocate each instruction to said fixed function arithmetic element or said reconfigurable arithmetic element, the instruction being included in a set of instructions which do not have any data dependency between the instructions; and
an instruction issuing unit operable to issue the allocated instruction to an allocation destination that is said fixed function arithmetic element or said reconfigurable arithmetic element to which the allocated instruction is allocated by said instruction allocation unit.

2. The processor according to claim 1,
wherein said instruction allocation unit is operable to allocate the instruction to said fixed function arithmetic element prior to said reconfigurable arithmetic element.

3. The processor according to claim 1,
wherein said instruction issuing unit is operable to issue a plurality of the allocated instructions in parallel to the allocation destinations, respectively.

4. The processor according to claim 1, further comprising
a configuration control unit operable to direct said reconfigurable arithmetic element to dynamically reconfigure a circuit configuration of said reconfigurable arithmetic element based on configuration information, when a predetermined instruction is allocated to said reconfigurable arithmetic element but the circuit configuration of said reconfigurable arithmetic element is not compliant to the predetermined instruction, the configuration information defining a circuit configuration compliant to the predetermined instruction.

5. The processor according to claim 1, further comprising
a configuration control unit operable to direct said reconfigurable arithmetic element to dynamically reconfigure a circuit configuration of said reconfigurable arithmetic element based on configuration information defining a circuit configuration compliant to at least two instructions,
wherein said instruction allocation unit is operable to allocate the at least two instructions to said reconfigurable function arithmetic element at the same time, and
said instruction issuing unit is operable to issue the at least two instructions to said reconfigurable function arithmetic element in parallel.

6. The processor according to claim 4,
wherein said configuration control unit is operable to insert a configuration instruction prior to the predetermined instruction, the configuration instruction instructing said reconfigurable arithmetic element to reconfigure the circuit configuration, and
said instruction issuing unit is operable to issue the predetermined instruction after issuing the configuration instruction.

7. An information processing apparatus in which the processor according to claim 1 is embedded, said information processing apparatus comprising:
a configuration information hold unit operable to hold configuration information defining an optimum circuit configuration for a software program to be executed;
an instruction storage unit in which an instruction code in an executable format is stored, the instruction code being generated based on a circuit configuration of said processor, and the circuit configuration of said processor being decided from the configuration information, and
a configuration control unit operable to direct said reconfigurable arithmetic element to reconfigure a circuit configuration of said reconfigurable arithmetic element to be correspond to the configuration information, prior to directing said processor to execute the instruction code.

8. The information processing apparatus according to claim 7, further comprising:
a template holding unit operable to hold a plural kinds of configuration information templates of the configuration information;
a software program holding unit operable to hold a plurality of software programs;
a software program decision unit operable to decide the software program to be executed, from among the plurality of software programs;
a template selection unit operable to select an optimum configuration information template for the software program to be executed, from among the plural kinds of configuration information templates;
a circuit configuration temporary decision unit operable to temporarily decide the circuit configuration of said processor, based on the optimum configuration information template selected by said template selection unit;
an instruction code generation unit operable to generate the instruction code in the executable format from the software program decided by said software program decision unit, based on the circuit configuration temporality decided by said circuit configuration temporary decision unit;
a threshold value determination unit operable to determine whether or not an execution cycle for the instruction code generated by said instruction code generation unit is equal to or less than a threshold value; and
an output unit operable to output the instruction code generated by said instruction code generation unit to said instruction storage unit, and the optimum configuration information template selected by said template selection unit to said configuration information hold unit, when the determination is made that the execution cycle is equal to or less than the threshold value.

9. The information processing apparatus according to claim 7, when the plurality of software programs are to be executed by time-sharing, further comprising
a switch unit operable to switch the software program to be executed to another for each predetermined time period,
wherein said configuration information hold unit is operable to hold the configuration information for each of the plurality of software programs,
said instruction storage unit is operable to hold the instruction code for each of the plurality of software programs, and
said configuration control unit is operable to direct said reconfigurable arithmetic element to reconfigure the circuit configuration of said reconfigurable arithmetic element, by switching the software program to be executed to another.

10. The information processing apparatus according to claim 9, further comprising
a table hold unit operable to hold a table in which each of the plurality of software program is associated with a circuit configuration,
wherein said configuration control unit is operable to specify a circuit configuration associated with a software program whose execution is to be directed to said processor, and direct said reconfigurable arithmetic element to reconfigure the circuit configuration of said reconfigurable arithmetic element based on configuration information defining the specified circuit configuration.

11. A processor control method of controlling a processor which includes a fixed function arithmetic element and a reconfigurable arithmetic element, the fixed function arithmetic element having a circuit configuration that is not dynamically reconfigurable, and the reconfigurable arithmetic element having a circuit configuration that is dynamically reconfigurable, said processor control method comprising:
allocating each instruction to the fixed function arithmetic element or the reconfigurable arithmetic element, the instruction being included in a set of instructions which do not have any data dependency between the instructions; and
issuing the allocated instruction to an allocation destination that is the fixed function arithmetic element or the reconfigurable arithmetic element to which the allocated instruction is allocated in said allocating.
